(19) United States
(12) Patent Application Publication
(10) Pub. No.: US 2021/0081172 A1
(43) Pub. Date: Mar. 18, 2021

(54) IMPLEMENTING TRANSCENDENTAL FUNCTIONS FOR DEEP LEARNING USING MULTIPARTITE LOOK UP TABLES

(71) Applicant: ADVANCED MICRO DEVICES, INC., Santa Clara, CA (US)

(72) Inventors: Prasad NAGABHUSHANAMGARI, Hyderabad (IN); Sateesh LAGUDU, Hyderabad (IN)

(21) Appl. No.: 16/571,728

(22) Filed: Sep. 16, 2019

(51) Int. Cl. G06F 7/483; G06F 7/544

(52) U.S. Cl. CPC G06F 7/4833; G06F 7/544

(57) ABSTRACT

A multipartite lookup table (LUT) is used to implement transcendental functions such as a binary logarithm, a binary anti-logarithm, or both. The multipartite LUT includes a plurality of LUTs that map partitions of bits representative of an input number to values of a transcendental function of the bits representative of the input number. The input number is in a first floating-point format. The implementation of the multipartite LUT includes output circuitry to combine the values of the transcendental function to produce an output number in a second floating-point format. The output number is equal to the transcendental function of the input number. Addresses of the plurality of LUTs are indicated by the partitions of the bits representative of the input number.

### BACKGROUND

Deep learning (DL) algorithms are implemented using neural networks such as convolutional neural networks (CNNs), deep neural networks (DNNs), recurrent neural networks (RNN), and the like. For example, CNNs are a class of artificial neural networks that learn how to perform tasks such as computer vision, driver assistance, image recognition, natural language processing, and game play. A CNN architecture includes a stack of layers that implement functions to transform an input volume (such as a digital image) into an output volume (such as labeled features detected in the digital image). The layers in a CNN are separated into convolutional layers, pooling layers, and fully connected layers. Multiple sets of convolutional, pooling, and fully connected layers are interleaved to form a complete CNN. The functions implemented by the layers in a CNN are explicit (i.e., known or predetermined) or hidden (i.e., unknown). A DNN is a type of CNN that performs deep learning on tasks that contain multiple hidden layers. For example, a DNN that is used to implement computer vision includes explicit functions (such as orientation maps) and multiple hidden functions in the hierarchy of vision flow. An RNN is a type of artificial neural network that forms a directed graph of connections between nodes along a temporal sequence and exhibits temporal dynamic behavior. For example, an RNN uses an internal state to process sequences of inputs. The RNN is typically applied to deep learning problems such as handwriting recognition and speech recognition. In some cases, an RNN is implemented with one or more long short-term memory (LSTM) units that provide feedback connections.

### BRIEF DESCRIPTION OF THE DRAWINGS

The present disclosure is better understood, and its numerous features and advantages made apparent to those skilled in the art by referencing the accompanying drawings. The use of the same reference symbols in different drawings indicates similar or identical items.

FIG. 1 is a block diagram of a processing system that implements transcendental functions using multipartite lookup tables (LUTs) according to some embodiments.

FIG. 2 is a block diagram that illustrates a deep neural network (DNN) that is trained to perform a task, such as a deep learning operation, according to some embodiments.

FIG. 3 is a block diagram of an arithmetic logic unit (ALU) that implements a transcendental function according to some embodiments.

FIG. 4 is a block diagram of a binary logarithm converter that determines a binary logarithm using a multipartite LUT according to some embodiments.

FIG. 5 is a block diagram of a binary anti-logarithm converter that determines a binary anti-logarithm using a multipartite LUT according to some embodiments.

FIG. 6 is a plot that compares a first function that is used to calculate a binary logarithm and a second function that is used to calculate a binary anti-logarithm according to some embodiments.

FIG. 7 is a plot of a first residue and a second residue relative to an independent variable according to some embodiments.

### DETAILED DESCRIPTION

Neural networks including convolutional neural networks (CNNs), deep neural networks (DNNs), and recurrent neural networks (RNN) implement algebraic arithmetic units such as addition and multiplication operations, as well as transcendental arithmetic units such as a binary logarithm (LOG 2) and a binary anti-logarithm (EXP2). The transcendental arithmetic units are used to realize activation functions (e.g., sigmoid and tan h in CNNs) and long short-term memory (LSTM) network layers in RNNs and DNNs. Floating-point formats are used to implement the transcendental arithmetic units and different formats make different trade-offs between hardware cost (e.g., area) and accuracy. For example, single-precision floating-point formats use one sign bit, eight exponent bits, and 23 mantissa bits to achieve high precision at a relatively high hardware cost. For another example, half-precision floating-point formats use one sign bit, five exponent bits, and 10 mantissa bits to reduce the hardware cost while tolerating a loss in output accuracy. Applications implemented in RNNs typically require high accuracy and therefore frequently implement the single-precision floating-point format. This requirement is particularly pertinent to LSTMs and other such implementations because the current output of the RNN depends on the previous output of the RNN. Errors in the computation of transcendental functions for the RNN therefore accumulate over iterations of the RNN. Furthermore, conventional techniques for computing single (or double) precision floating-point transcendental functions require numerous computation cycles to achieve the required accuracy, which adds performance-sapping latency to the computation.

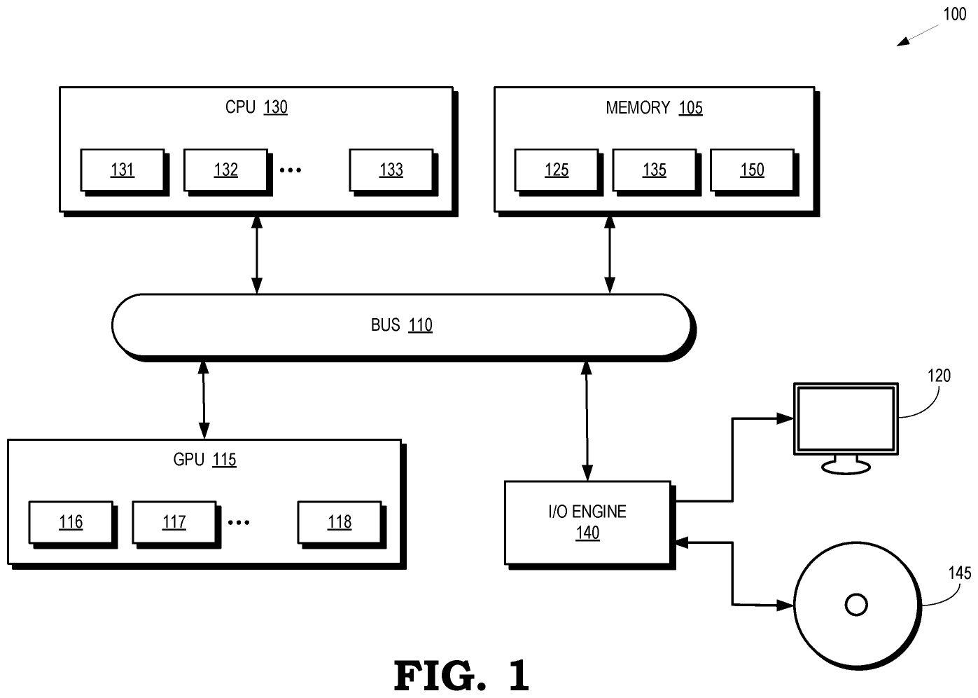

FIGS. 1-5 disclose transcendental arithmetic units that are implemented using multipartite lookup tables (LUTs) to achieve high precision, and throughput as high as one sample for every clock cycle, in an architecture that provides a reasonable area-accuracy trade-off. A transcendental arithmetic unit receives an input in floating-point format that represents the input as a sign bit, a first number of exponent bits, and a second number of mantissa bits. The transcendental arithmetic unit performs the transcendental function (e.g., binary logarithm or binary anti-logarithm) to generate an output in a floating-point format. The area required to implement the transcendental arithmetic unit is reduced compared to conventional approaches by using a plurality of LUTs to convert partitions of the bits that represent the input into corresponding contributions to the output value of the transcendental function. For example, in some embodiments, the floating-point format includes 23 mantissa bits and three LUTs are used to convert the partitions of the bits that represent the input into the output value of the transcendental function. If the transcendental arithmetic unit implements a binary logarithm, the mantissa bits are partitioned into three partitions, e.g., partitions including ten bits, ten bits, and three bits. If the transcendental arithmetic unit implements a binary anti-logarithm, the floating-point input is used to generate bits that represent a fractional value and these bits are partitioned into three partitions.

Addresses of the LUTs associated with the partitions are generated using the bits in the corresponding partitions. For example, a first address of a first LUT associated with a first partition of the bits representative of an input is generated using the bits in the first partition, a second address of a second LUT associated with a second partition of the input bits is generated using the bits in the second partition, and a third address of a third LUT associated with a third partition of the input bits is generated using the bits in the third partition. Entries in the LUTs represent values of outputs corresponding to the input to the transcendental arithmetic unit. Some embodiments of the transcendental arithmetic unit implement a binary logarithm function and the entries in the LUTs map bits in the partitions of the input mantissa to mantissas of the binary logarithms of the inputs (with values between one and two when represented in the floating-point format). Some embodiments of the transcendental arithmetic unit implement a binary anti-logarithm function and the entries in the LUTs map bits representing a fraction of the input to a mantissa of a fraction of the anti-logarithm of the inputs (with values between zero and one when represented in the floating-point format).

FIG. 1 is a block diagram of a processing system 100 that implements transcendental functions using multipartite LUTs according to some embodiments. The processing system 100 includes or has access to a memory 105 or other storage component that is implemented using a non-transitory computer readable medium such as a dynamic random access memory (DRAM), static random access memory (SRAM), nonvolatile RAM, and the like. The processing system 100 also includes a bus 110 to support communication between entities implemented in the processing system 100, such as the memory 105. Some embodiments of the processing system 100 include other buses, bridges, switches, routers, and the like, which are not shown in FIG. 1 in the interest of clarity.

The processing system 100 includes a graphics processing unit (GPU) 115 that renders images for presentation on a display 120. For example, the GPU 115 renders objects to produce values of pixels that are provided to the display 120, which uses the pixel values to display an image that represents the rendered objects. Some embodiments of the GPU 115 are used to implement deep learning operations including CNNs, DNNs, and RNNs, as well as performing other general-purpose computing tasks. In the illustrated embodiment, the GPU 115 implements multiple processing elements 116, 117, 118 (collectively referred to herein as “the processing elements 116-118”) that executes instructions concurrently or in parallel. In the illustrated embodiment, the GPU 115 communicates with the memory 105 over the bus 110. However, some embodiments of the GPU 115 communicate with the memory 105 over a direct connection or via other buses, bridges, switches, routers, and the like. The GPU 115 executes instructions stored in the memory 105 and the GPU 115 stores information in the memory 105 such as the results of the executed instructions. For example, the memory 105 stores a copy 125 of instructions from a program code that is to be executed by the GPU 115.

The processing system 100 also includes a central processing unit (CPU) 130 that implements multiple processing elements 131, 132, 133, which are collectively referred to herein as “the processing elements 131-133.” The processing elements 131-133 execute instructions concurrently or in parallel. The CPU 130 is connected to the bus 110 and therefore communicates with the GPU 115 and the memory 105 via the bus 110. The CPU 130 executes instructions such as program code 135 stored in the memory 105 and the CPU 130 stores information in the memory 105 such as the results of the executed instructions. The CPU 130 is also able to initiate graphics processing by issuing draw calls to the GPU 115.

An input/output (I/O) engine 140 handles input or output operations associated with the display 120, as well as other elements of the processing system 100 such as keyboards, mice, printers, external disks, and the like. The I/O engine 140 is coupled to the bus 110 so that the I/O engine 140 communicates with the memory 105, the GPU 115, or the CPU 130. In the illustrated embodiment, the I/O engine 140 reads information stored on an external storage component 145, which is implemented using a non-transitory computer readable medium such as a compact disk (CD), a digital video disc (DVD), and the like. The I/O engine 140 also writes information to the external storage component 145, such as the results of processing by the GPU 115 or the CPU 130.

Artificial neural networks, such as a CNN, DNN, or RNN, are represented as program code that is configured using a corresponding set of parameters. The artificial neural network is therefore executed on the GPU 115, the CPU 130, or other processing units including field programmable gate arrays (FPGA), application-specific integrated circuits (ASIC), processing in memory (PIM), and the like. If the artificial neural network implements a known function that is trained using a corresponding known dataset, the artificial neural network is trained (i.e., the values of the parameters that define the artificial neural network are established) by providing input values of the known training data set to the artificial neural network executing on the GPU 115 or the CPU 130 and then comparing the output values of the artificial neural network to labeled output values in the known training data set. Error values are determined based on the comparison and back propagated to modify the values of the parameters that define the artificial neural network. This process is iterated until the values of the parameters satisfy a convergence criterion.

As discussed herein, neural networks in the processing system 100 include transcendental arithmetic units that implement transcendental functions such as a binary logarithm (LOG 2) or a binary anti-logarithm (EXP2). The transcendental arithmetic units are used, for example, to realize activation functions (e.g., sigmoid and tan h in CNNs) and long short-term memory (LSTM) network layers in RNNs and DNNs. Floating-point formats are used to implement the transcendental arithmetic units and different formats make different trade-offs between hardware cost (e.g., area) and accuracy. In order to achieve high precision, and throughput as high as one sample for every clock cycle, in an architecture that provides a reasonable area-accuracy trade-off the processing system implements multipartite LUTs to calculate the transcendental functions. Some embodiments of the multipartite LUTs include a set of LUTs and each LUTs in the set maps partitions of bits representative of an input number to values of a transcendental function of the bits representative of the input number in a floating-point format. The values of the transcendental function are combined to produce an output number in a floating-point format, which is the same or different than the floating-point format of the input number. The value of the output number is equal to the transcendental function of the input number. In some embodiments, the set of LUTs 150 is stored in the memory 105 and addresses of the LUTs 150 in the memory 105 are indicated by the partitions of the bits representative of the input number.

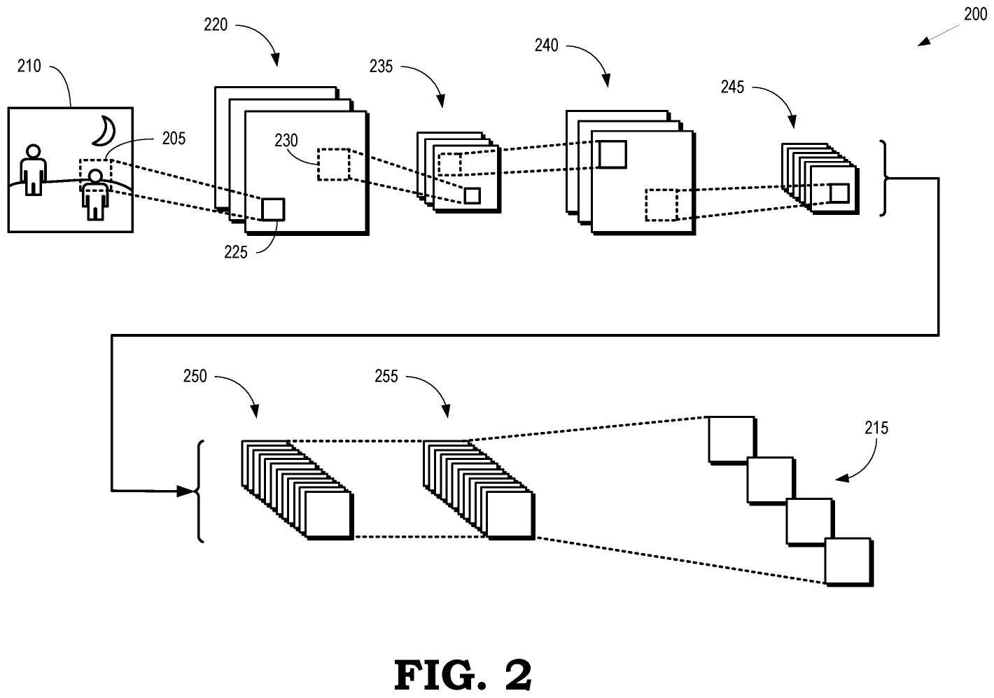

FIG. 2 is a block diagram that illustrates a deep neural network (DNN) 200 that is trained to perform a task such as a deep learning operation according to some embodiments. The DNN 200 is executed on the processing elements 116-118 in the GPU 115 or the processing elements 131-133 in the CPU 130 shown in FIG. 1. The DNN 200 receives input values such as a portion 205 of an image 210 and produce output values 215 using functions implemented in the DNN 200 and values of parameters that define the functions.

The DNN 200 includes convolutional layers 220 that implement a convolutional function that is defined by a set of parameters, which are trained with one or more training datasets. The parameters include a set of learnable filters (or kernels) that have a small receptive field and extend through a full depth of an input volume of convolutional layers 220. The parameters also include, but are not limited to, a depth parameter, a stride parameter, and a zero-padding parameter that control the size of the output volume of the convolutional layers 220. The convolutional layers 220 apply a convolution operation to input values and provide the results of the convolution operation to a subsequent layer in the DNN 200. For example, the portion 205 of the image 210 is provided as input 225 to the convolutional layers 220, which apply the convolution operation to the input 225 based on the set of parameters to generate a corresponding output value 230. In some embodiments, the convolutional layers 220 are identified as a subnetwork of the DNN 200. The subnetwork then represents a convolutional neural network (CNN). However, in some embodiments, the convolutional layers 220 are a part of a larger subnetwork of the DNN 200 or the convolutional layers 220 are further subdivided into multiple subnetworks of the DNN 200.

Results generated by the convolutional layers 220 are provided to pooling layers 235 in the DNN 200. The pooling layers 235 combine outputs of neuron clusters at the convolutional layers 220 into a smaller number of neuron clusters that are output from the pooling layers 235. The pooling layers 235 typically implement known (or explicit) functions. For example, pooling layers 235 that implement maximum pooling assign a maximum value of values of neurons in a cluster that is output from the convolutional layers 220 to a single neuron that is output from the pooling layers 235. For another example, pooling layers 235 that implement average pooling assign an average value of the values of the neurons in the cluster that is output from the convolutional layers 220 to a single neuron that is output from the pooling layers 235. The known (or explicit) functionality of the pooling layers 235 is trained using predetermined training datasets. In some embodiments, the pooling layers 235 are identified as a subnetwork of the DNN 200. However, in some cases, the pooling layers 235 is a part of a larger subnetwork of the DNN 200 or the pooling layers 235 is further subdivided into multiple subnetworks of the DNN 200.

In the illustrated embodiment, the DNN 200 also includes additional convolutional layers 240 that receive input from the pooling layers 235 and additional pooling layers 245 that receive input from the additional convolutional layers 240. However, the additional convolutional layers 240 and the additional pooling layers 245 are optional and are not present in some embodiments of the DNN 200. Furthermore, some embodiments of the DNN 200 include larger numbers of convolutional and pooling layers. The additional convolutional layers 240 and the additional pooling layers 245 are identified as subnetworks of the DNN 200, portions of subnetworks of the DNN 200, or they are subdivided into multiple subnetworks of the DNN 200.

Output from the additional pooling layers 245 is provided to fully connected layers 250, 255. The neurons in the fully connected layers 250, 255 are connected to every neuron in another layer, such as the additional pooling layers 245 or the other fully connected layers. The fully connected layers 250, 255 typically implement functionality that represents the high-level reasoning that produces the output values 215. For example, if the DNN 200 is trained to perform a deep learning operation such as computer vision, driver assistance, image recognition, natural language processing, or game play, the fully connected layers 250, 255 implement the functionality that labels portions of the image that have been “recognized” by the DNN 200. Examples of labels include names of people whose faces are detected in the image 210, types of objects detected in the image, and the like. The functions implemented in the fully connected layers 250, 255 are represented by values of parameters that are determined using a training dataset, as discussed herein. The fully connected layers 250, 255 are identified as subnetworks of the DNN 200, portions of subnetworks of the DNN 200, or they are subdivided into multiple subnetworks of the DNN 200.

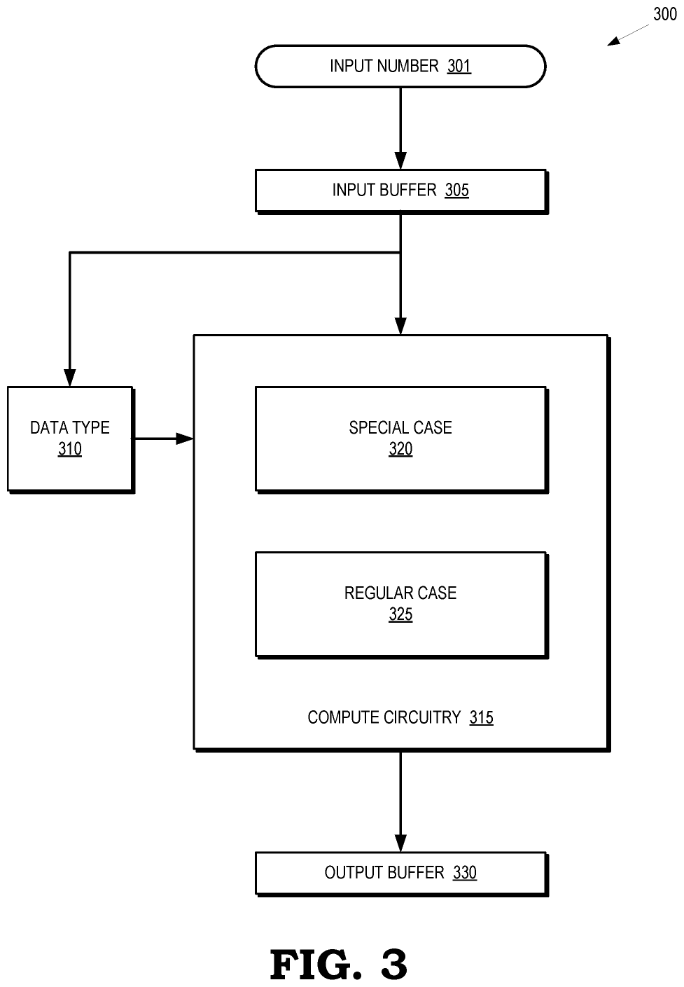

FIG. 3 is a block diagram of an arithmetic logic unit (ALU) 300 that implements a transcendental function according to some embodiments. The ALU 300 is implemented in some embodiments of the processing system 100 shown in FIG. 1. The ALU 300 receives an input number 301 in a floating-point format (such as single precision FP32) and the input number 301 is stored in a register or buffer 305. A data type extractor 310 extracts the data type of the input number 301. Examples of the data type include infinity, normalized number, and not a number (NaN). The data type extractor 310 provides information indicating the data type of the input number 301 to compute circuitry 315. Special case circuitry 320 in the compute circuitry 315 addresses computations of special cases of the input number 305 in response to the signal from the data type extractor 310 indicating a special case number. Examples of the special case number include, but are not limited to, IEEE exceptions and standard/default values of special input values including infinity and NaN. Regular case circuitry 325 in the compute circuitry 315 performs computations of regular numbers that do not fall under the special cases. The compute circuitry 315 generates output for the special or normal cases and provides the output in a floating-point format to a register or buffer 330. The floating-point format of the number stored in the output buffer 330 is not necessarily the same as the floating-point format of the input number 301 that is stored in the input buffer 305. For example, the number stored in the output buffer 330 is FP32, FP24, FP16, or other format in different cases.

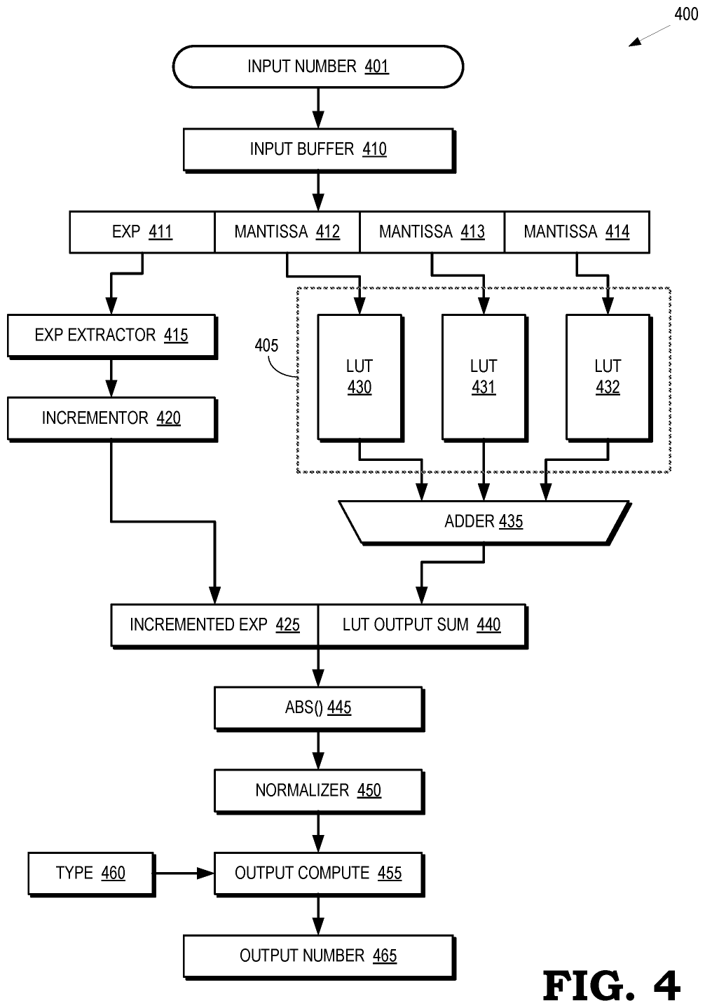

FIG. 4 is a block diagram of a binary logarithm converter 400 that determines a binary logarithm using a multipartite LUT 405 according to some embodiments. The binary logarithm converter 400 is used to implement some embodiments of the regular case circuitry 325 shown in FIG. 3. An input number 401 is provided to the binary logarithm converter 400 from a buffer 410. In the illustrated embodiment, contents for the multipartite LUT are generated using a functional approximation for inputs in ranges:

1≤A,B,C<2

1≤A+B+C<2

Within these ranges, the transcendental function is approximated as:

f(A+B+C)≈f(A)+f(B)+f(C)

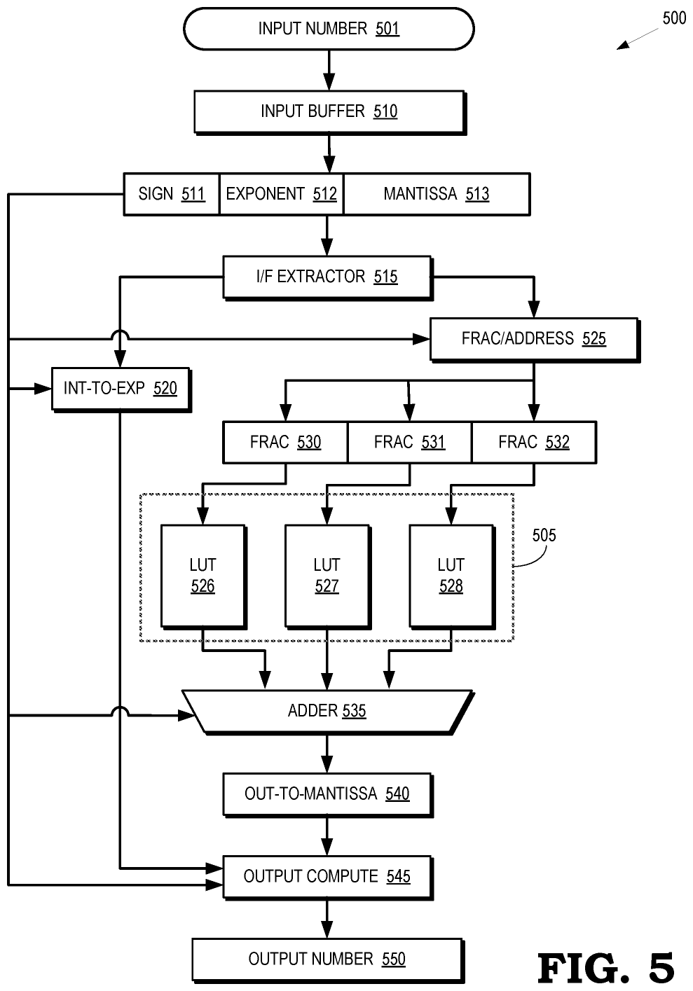

A similar approximation is also applied in a binary anti-logarithm converter 500 shown in FIG. 5. In some embodiments, the values A, B, C are the partitions of the mantissa bits of the input number 401 for the binary logarithm converter 400 and are the adjusted fraction bits of an input number of a binary anti-logarithm converter, respectively.

The input number 401 is partitioned into exponent bits 411 and partitions 412, 413, 414 of the mantissa bits of the input number 401 in the floating-point format. Some embodiments of the input number 401 are represented as an IEEE floating-point number, N:

N=(−1)^{Sign}×2^{Exponent+Bias}×(H.M)₂

where Sign is the sign bit of the input number 401, Exponent is its true exponent value, Bias is the bias introduced by the IEEE standard, H is the hidden bit of the significand that is either 1 or 0 depending on the number being a normal number or a subnormal number, and M is the mantissa of the input number 401. For the IEEE single-precision format, the input number 401 includes one sign bit, eight exponent bits, and 23 mantissa bits. If the hidden bit is included in the mantissa, the significand of the mantissa becomes a 24-bit value.

Some embodiments of the significand of the mantissa are represented in real format for calculating the binary logarithm of the significand. For example, the significand of the mantissa M is represented in real format as:

$$\begin{matrix}{log}_{2} ( 1 + M ) = & {log}_{2} ( 1 {M}_{22} {M}_{21} … {M}_{0} ) \\ = & {log}_{2} ( 10000000000000000000000000000 + \\ & 0 {M}_{22} {M}_{21} … {M}_{13} 0000000000000 + \\ & 00000000000 {M}_{12} {M}_{11} … {M}_{4} 0000 + \\ & 00000000000000000000 {M}_{3} {M}_{2} {M}_{1} {M}_{0} )\end{matrix}$$

which is approximated as:

log₂(1+M)≈0+log₂(M₂₂M₂₁ . . . M₁₃ 0000000000000)+log₂(0000000000M₁₂M₁₁ . . . M₄0000)+log₂(0000000000000000000M₃M₂M₁M₀)

This approximation is used to determine the binary logarithm of the input number 401. In some embodiments, the values of the arguments to above formula for the binary logarithm serve as addresses for corresponding LUTs 430, 431, 432 (which are collectively referred to herein as “the LUTs 430-432”) in the multipartite LUT 405.

The value of the exponent 411 is provided to an exponent extractor 415 to extract the exponent from the input number 401 and the results are provided to an incrementor 420, which generates an incremented exponent 425. The exponent of a floating-point number N is extracted through an exponent extractor 415 as:

Extracted Exponent=(Exponent+Bias)−(Bias+1)

Values of the partitions 412-414 of the mantissa bits are provided to the corresponding LUTs 430-432 in the multipartite LUT 405. Unlike previous multipartite implementations that determine address bits into the multipartite LUT 405 using bits from the multiple partitions, the binary logarithm converter 400 generates address bits of each of the individual LUTs 430-432 from a single corresponding partition of the input bits. For example, the address bits into the LUT 430 are generated based on the partition 412, the address bits into the LUT 431 are generated based on the partition 413, and the address bits into the LUT 432 are generated based on the partition 414. This approach reduces the number of words in the LUTs 430-432, as well as the size of each word in the LUTs 430-432, depending on the contents of the LUTs 430-432 obtained from the approximation discussed above.

The LUTs 430-432 contain the mantissas of the binary logarithms of inputs between the range of one and two, one represented in a floating-point format. In some embodiments, the contents of the LUTs 430-432 are determined using the following:

LUT 430: 1+(i+2⁻¹⁰),∀i∈[0,1023]

LUT 431: 1+(i+2⁻¹⁹),∀i∈[0,511]

LUT 432: 1+(i+2⁻²³),∀i∈[0,15]

The values generated by the LUTs 430-432 based on the partitions 412-414 of the mantissa bits are provided to an adder 435, which combines the values to form and LUT output sum 440.

The binary logarithm converter 400 includes ABS circuitry 445 that combines the LUT output sum 440 with the incremented true exponent 425 to generate a fixed point representation of an output value, which is provided to a normalizer 450. Output compute circuitry 455 uses a normalized output value generated by the normalizer 450 to compute the output in floating-point format. The output compute circuitry 455 also configures the precision format of the output according to a return type generated by a type generator 460. The output number is then provided to a buffer 465. Some embodiments of the output compute circuitry 455 are implemented as hard-coded logic, programmable logic, or a combination thereof, as well as supporting analog circuitry (e.g., resistors, capacitors, inductors, terminals, vias, contacts, leads or traces, and the like).

FIG. 5 is a block diagram of a binary anti-logarithm converter 500 that determines a binary anti-logarithm using a multipartite LUT 505 according to some embodiments. The binary anti-logarithm converter 500 is used to implement some embodiments of the regular case circuitry 325 shown in FIG. 3. An input number 501 is provided to the binary anti-logarithm converter 500 from a buffer 510. The input number 501 is partitioned into a sign bit 511, exponent bits 512, and mantissa bits 513. The binary anti-logarithm converter 500 determines the binary anti-logarithm value of a fraction part of the input 510 using the mantissa bits 513 and the multipartite LUT 505. In some cases, the fraction obtained from the mantissa bits 513 does not include the same number of bits (e.g., 23 bits) for every input number. The number of bits in the fraction is therefore adjusted to a target number of bits such as 23 bits, as discussed below.

An integer/fraction extractor 515 accesses the bits 511-513 that represent the input number 501 and extracts an integer (e.g., one or more integer bits) and a fraction (e.g., one or more fraction bits) of the input number 501 from the exponent bits 512 and the mantissa bits 513. An integer-to-exponent converter 520 generates an output exponent based on the integer provided by the integer/fraction extractor 515 and the sign bit 511.

The integer/fraction extractor 515 provides bits representing the fraction to fraction/address circuitry 525 that adjusts the number of bits in the fraction and generates addresses into a set of LUTs 526, 527, 528 (which are collectively referred to as “the LUTs 526-528”) in the multipartite LUT 505. The fraction/address circuitry 525 adjust the number of bits in the fraction to a format that includes the target number of bits, e.g., by adding one or more trailing zeros so that the total number of bits in the fraction is equal to the target number such as 23 bits. The fraction/address circuitry 525 partitions the bits in the bit-adjusted fraction into partitions 530, 531, 532, which are collectively referred to as “the partitions 530-532.”

For example, if the input number 501 is represented as N=I.F, where I is the integer portion and F is the fraction portion of the input number 501, the addresses of the LUTs 526-528 are generated by adjusting the positions of the bits of F to form a number having a target number of bits such as 23 bits. In that case,

EXP2(N)=EXP2(1.F)=EXP2(1.0+0.F)

Representing the above expression with the bit fields produces:

EXP2(1.0+0.F)=EXP2(1.0)×EXP2(0.F)

The binary anti-logarithm of the fraction is determined using the information in the LUTs 526-528 after adjusting the fraction to the target number of bits, which in this case is 23 bits. This leads to the expression:

EXP2(0.F)=EXP2(F₂₂F₂₁F₂₀ . . . F₁F₀)

The address values for the LUTs 526-528 are then determined based on the partitions 530-532, e.g., using:

EXP2(0.F)≈EXP2(F₂₂F₂₁. . . F₁₃0000000000000)+EXP2(0000000000F₁₂F₁₁ . . . F₃000)+EXP2(00000000000000000000F₂F₁F₀)

The LUTs 526-528 contain the mantissa of the fraction of the anti-logarithm of the inputs between zero and one, when represented in the floating-point format. In some embodiments, the contents of the LUTs 526-528 are determined using the following:

LUT 526: 1+(i+2⁻¹⁰),∀i∈[0,1023]

LUT 527: 1+(i+2⁻²⁰),∀i∈[0,1023]

LUT 528: 1+(i+2⁻²³),∀i∈[0,7]

The values generated by the LUTs 526-528 based on the partitions 530-532 of the fraction bits are provided to an adder 535, which combines the values and provides the combined values to a converter 540 that converts the LUT output to a mantissa value for the output number. Output compute circuitry 545 uses a mantissa value generated by the converter 540 and the exponent value generated by the integer-to-exponent converter 520 to compute the output in floating-point format. The output number is then provided to a buffer 550. Some embodiments of the output compute circuitry 545 are implemented as hard-coded logic, programmable logic, or a combination thereof, as well as supporting analog circuitry (e.g., resistors, capacitors, inductors, terminals, vias, contacts, leads or traces, and the like).

Applications or functions implemented in a deep learning operation often require more than one transcendental function. For example, some operations implemented by the processing system 100 shown in FIG. 1, the DNN 200 shown in FIG. 2, or the arithmetic logic unit 300 shown in FIG. 3 require both a binary logarithm function (such as the binary logarithm function implemented in the binary logarithm converter 400 shown in FIG. 4) and a binary anti-logarithm function (such as the binary anti-logarithm converter 500 shown in FIG. 5). Implementing a separate LUT for each transcendental function used by the deep learning operation increases the LUT size requirement, e.g., the area and power consumed by separate LUTs doubles relative to a single LUT if two transcendental functions are implemented. However, a single LUT is sufficient to determine multiple transcendental functions if symmetries exist between the functional representations of the transcendental functions that allow both the transcendental functions to be derived from a single LUT.

As discussed above, the LUTs 430-432 shown in FIG. 4 are used to determine mantissa bits of binary logarithms of inputs between a range of one and two using the equation log₂(1+M), where M is the mantissa. The LUTs 526-528 shown in FIG. 4 are used to determine fraction bits of binary anti-logarithms of inputs between a range of zero and one using the equation EXP2(1.0+0. F).

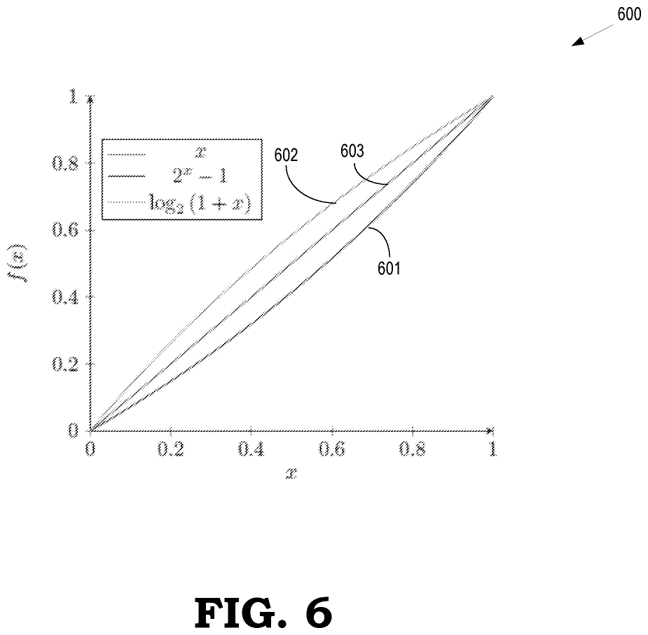

FIG. 6 is a plot 600 that compares a first function 601 that is used to calculate a binary logarithm and a second function 602 that is used to calculate a binary anti-logarithm according to some embodiments. The first function 601 and the second function 602 are compared to values of an independent variable 603. In the illustrated embodiment, the first function 601 represents the function log₂ (1+x) and the second function 602 represents the function 2^{x}−1. The plot 600 illustrates that the first function 601 and the second function 602 are almost symmetric with respect to the independent variable 603, e.g., the variable x within the range of 0≤x<1.

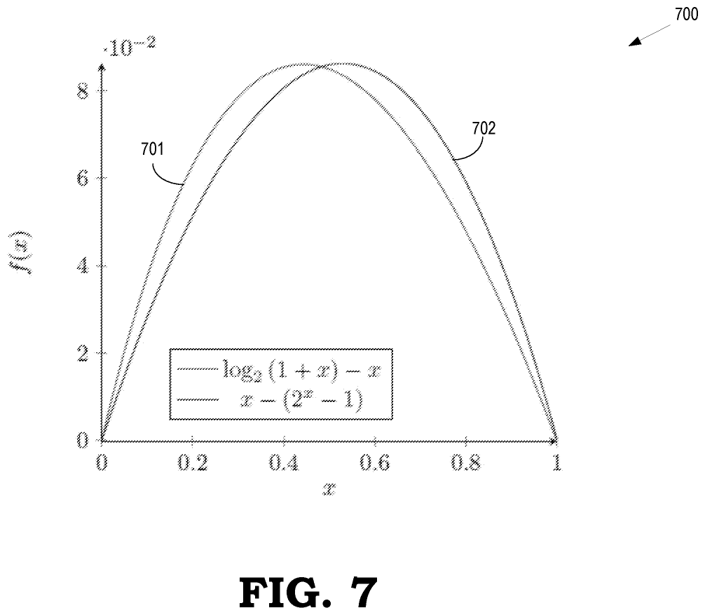

FIG. 7 is a plot 700 of a first residue 701 and a second residue 702 relative to an independent variable according to some embodiments. The first residue 701 represents a difference between the first function 601 and the independent variable 603 shown in FIG. 6. The second residue 702 represents a difference between the second function 602 and the independent variable 603 shown in FIG. 6. A net residue E that represents an asymmetry between the first function 601 and the second function 602 is defined as:

Δx₁=log₂(1+x)−x

Δx₂=x−(2^{x}−1)

∈=Δx₁−Δx₂

The plot 700 indicates that the residue ranges from 0-0.08 in the range 0≤x<1. The asymmetry indicated by the net residue can therefore be safely ignored in relatively error-resilient applications that implement both binary logarithm and binary anti-logarithm functions. In that case, a single set of LUTs for one of the functions log₂(1+x) and 2^{x}−1 is used to derive values for both types of functions, as needed.

A computer readable storage medium includes any non-transitory storage medium, or combination of non-transitory storage media, accessible by a computer system during use to provide instructions and/or data to the computer system. Such storage media includes, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium is embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above are implemented by one or more processors of a processing system executing software. The software includes one or more sets of executable instructions stored or otherwise tangibly embodied on a non-transitory computer readable storage medium. The software includes the instructions and certain data that, when executed by the one or more processors, manipulate the one or more processors to perform one or more aspects of the techniques described above. The non-transitory computer readable storage medium includes, for example, a magnetic or optical disk storage device, solid state storage devices such as Flash memory, a cache, random access memory (RAM) or other non-volatile memory device or devices, and the like. The executable instructions stored on the non-transitory computer readable storage medium is in source code, assembly language code, object code, or other instruction format that is interpreted or otherwise executable by one or more processors.

Note that not all of the activities or elements described above in the general description are required, that a portion of a specific activity or device is not required, and that one or more further activities are performed, or elements included, in addition to those described. Still further, the order in which activities are listed are not necessarily the order in which they are performed. Also, the concepts have been described with reference to specific embodiments. However, one of ordinary skill in the art appreciates that various modifications and changes are made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An apparatus, comprising:
a plurality of lookup tables (LUTs) configured to map partitions of bits representative of an input number to values of a transcendental function of the bits representative of the input number, wherein the input number is in a first floating-point format; and
output circuitry configured to combine the values of the transcendental function to produce an output number in a second floating-point format, wherein the output number is equal to the transcendental function of the input number.

2. The apparatus of claim 1, wherein addresses of the plurality of LUTs are indicated by the partitions of the bits representative of the input number.

3. The apparatus of claim 2, wherein:
the transcendental function is a binary logarithm function,
the partitions of the bits representative of the input number comprise partitions of mantissa bits that represent the input number in the first floating-point format, and
the plurality of LUTs map the partitions of the mantissa bits to mantissa bits of binary logarithms of inputs between a range of one and two when represented in the first floating-point format.

4. The apparatus of claim 3, wherein the output circuitry is configured to combine the values of the mantissa bits of the binary logarithms and values of exponent bits representative of the input number to produce the output number in the second floating-point format.

5. The apparatus of claim 2, wherein the transcendental function is a binary anti-logarithm function, and further comprising:
integer/fraction extraction circuitry to generate integer bits and fraction bits based on a sign bit, exponent bits, and mantissa bits that represent the input number in the first floating-point format.

6. The apparatus of claim 5, wherein the partitions of the bits representative of the input number comprise partitions of the fraction bits representative of the input number, and wherein the plurality of LUTs map the partitions of the fraction bits to values of mantissa bits of the binary anti-logarithm of inputs between zero and one, when represented in the first floating-point format.

7. The apparatus of claim 6, further comprising:
first converter configured to generate mantissa bits representative of the output number in the second floating-point format based on the fractions of the anti-logarithm; and
second converter configured to generate output exponent bits based on the sign bit and the integer bits.

8. The apparatus of claim 7, wherein the output circuitry is configured to combine the output exponent bits and the mantissa bits representative of the output number to produce the output number in the second floating-point format.

9. The apparatus of claim 2, wherein:
the transcendental function comprises a binary logarithm function and a binary anti-logarithm function, and
mantissa bits of binary logarithms of inputs between a range of one and two and mantissa bits of the binary anti-logarithm of inputs between zero and one are generated based on the plurality of LUTs assuming symmetry of the binary logarithm function of a significand of the input number and the binary anti-logarithm function of a fraction part of the input number, respectively, within the range of zero and one.

10. A method, comprising:
mapping, using a plurality of lookup tables (LUTs), partitions of bits representative of an input number stored in an input buffer to values of a transcendental function of the bits representative of the input number, wherein the input number is in a first floating-point format; and
providing an output number to an output buffer in a second floating-point format based on the values of the transcendental function of the bits representative of the input number stored in the plurality of LUTs, wherein the output number is equal to the transcendental function of the input number.

11. The method of claim 10, further comprising:
generating addresses of the plurality of LUTs based on the partitions of the bits representative of the input number.

12. The method of claim 11, wherein:
the transcendental function is a binary logarithm function,
the partitions of the bits representative of the input number comprise partitions of mantissa bits that represent the input number in the first floating-point format, and
mapping the partitions of the bits representative of the input number comprises mapping the partitions of the mantissa bits to mantissa bits of binary logarithms of inputs between a range of one and two, when represented in the first floating-point format.

13. The method of claim 12, further comprising:
combining the values of the mantissa bits of the binary logarithms and values of exponent bits representative of the input number to produce the output number in the second floating-point format.

14. The method of claim 11, wherein the transcendental function is a binary anti-logarithm function, and further comprising:
generating integer bits and fraction bits based on a sign bit, exponent bits, and mantissa bits that represent the input number in the first floating-point format.

15. The method of claim 14, wherein:
the partitions of the bits representative of the input number comprise partitions of the fraction bits representative of the input number, and
mapping the partitions of the bits representative of the input number comprises mapping the partitions of the fraction bits to values of mantissa bits of the binary anti-logarithm of inputs between zero and one, when represented in the first floating-point format.

16. The method of claim 15, further comprising:
generating mantissa bits representative of the output number in the second floating-point format based on the fraction bits; and
generating output exponent bits based on the sign bit and the integer bits.

17. The method of claim 16, further comprising:
combining the output exponent bits and the mantissa bits representative of the output number to produce the output number in the second floating-point format.

18. The method of claim 11, wherein the transcendental function comprises a binary logarithm function and a binary anti-logarithm function, and further comprising:
generating mantissa bits of binary logarithms of inputs between a range of one and two and mantissa bits of the binary anti-logarithm of inputs between zero and one based on the plurality of LUTs assuming symmetry of the binary logarithm function of a significand of the input number and the binary anti-logarithm function of a fraction part of the input number, respectively, within the range of zero and one.

19. A method, comprising:
providing bits in partitions of a set of mantissa bits that represent an input number stored in an input buffer in a first floating-point format to corresponding ones of a plurality of lookup tables (LUTs) using addresses of the plurality of LUTs that are determined by the bits in the partitions; and
providing an output number to an output buffer in a second floating-point format based on values stored in the plurality of LUTs, wherein the values represent portions of a transcendental function of the input number.

20. The method of claim 19, wherein the transcendental function is at least one of a binary logarithm and a binary anti-logarithm.
